(19) United States
(12) Patent Application Publication
(10) Pub. No.: US 2013/0074646 A1
(43) Pub. Date: Mar. 28, 2013

(54) DAMPER GEAR STRUCTURE OF A BODY-BUILDING APPARATUS

(71) Applicant: Yung-Sung YEH, New Taipei City (TW)

(72) Inventor: Yung-Sung YEH, New Taipei City (TW)

(21) Appl. No.: 13/586,253

(22) Filed: Aug. 15, 2012

(30) Foreign Application Priority Data
Sep. 23, 2011 (TW) 100217842

(51) Int. Cl. F16F 15/30

(52) U.S. Cl. 74/572.21

(57) ABSTRACT

A damper gear structure of a body-building apparatus features a unique structure with the central through-hole and driving shaft lever not contacting each other and forming a ring-shaped interval, and an additional configuration of a connecting and positioning member to combine the driving shaft lever with the damper gear main body. The damper gear can deviate the driving and connecting part beyond the outer diameter of the driving shaft lever to increase the lever arm when the driving shaft lever drives the damper gear main body, and achieves the same revolving inertia with a reduced outer diameter of the damper gear main body. In this way, the operational and production cost effectiveness are both improved. Moreover, due to the reduced outer diameter of the damper gear main body, the peripheral components can be closer or smaller, and consequently the body-building apparatus can have a light and handy design.

### CROSS-REFERENCE TO RELATED U.S. APPLICATIONS

Not applicable.

### STATEMENT REGARDING FEDERALLY SPONSORED RESEARCH OR DEVELOPMENT

Not/applicable.

### NAMES OF PARTIES TO A JOINT RESEARCH AGREEMENT

Not/applicable.

REFERENCE TO AN APPENDIX SUBMITTED ON COMPACT DISC

Not applicable.

BACKGROUND OF THE INVENTION

1. Field of the Invention

The present invention relates generally to a damper gear structure of a body-building apparatus, and more particularly to an innovative one with increased lever arm to push the shaft lever to drive the damper gear body.

2. Description of Related Art Including Information Disclosed Under 37 CFR 1.97 and 37 CFR 1.98

A damper gear (also called a flywheel) is a necessary configuration on the structure of commonly used sport and body-building apparatuses like pedal exercise bikes, elliptical trainers, etc. to provide proper resistance when operating the body-building apparatus, so as to accomplish the expected sport and exercise efficacy.

As a typical driving mechanism of the damper gear of commonly used sport and body-building apparatus, a big belt pulley is fitted on the crank shaft, the damper gear is fitted on the interval position of the crank shaft, and a small belt pulley is fitted on one side of the damper gear center, so that the big belt pulley and small belt pulley can be connected through a belt for driving action. In this way, upon circular motion of the crank shaft, the connection state of the big belt pulley, belt and small belt pulley can drive the damper gear to revolve. Now, based on the inertia (or centrifugal force) generated by the proper weight of the damper gear during the revolving and the resistance generated by a matching magnetic control resistance device against the damper gear, the user can have variable and adjustable force during the exercise, and therefore can achieve better exercise or amusement effect. However, a couple of shortcomings are found during actual usage of such a prior-art structure. For example, a welding deformation of the frame may easily cause sliding, escaping, turning or even breakage or excessive noise of the belt on the aligned fitting positions, and the difficulty in assembly and adjustment will increase the labor and time cost as well as defective rate.

In view of the above problems and shortcomings, some manufacturers developed a simpler structure to combine the damper gear directly with the crank shaft. Such a modified structure considerably reduced the costs of material, assembly and production by omitting the driving mechanisms of belt and belt pulleys, and indeed solved the above-mentioned problems caused by belt driving.

However, such a prior-art structure of direct combination between the damper gear and the crankshaft derives another problem to be solved.

Referring to FIG. 1 for the damper gear directly combined with the crank shaft, an axle hole 11 is configured on the center of the damper gear 10 to fit the crank shaft 12 tightly. In this way, when the crank shaft 12 receives a force (for example, foot step) and revolves, it will directly drive the damper gear 10 to revolve. Based on the known torque equation (i.e., torque=lever arm×force), the distance W1 between, the axle center 13 of the crank shaft 12 to the axle hole 11 is the lever arm in the torque equation, the final revolving inertia (centrifugal force) of the damper gear 10 is the torque in the equation, and the force acting on the crank shaft 12 is the force in the equation. From this torque equation and physical principles, it is not difficult to understand the relations between the three factors. For example, when the force factor is fixed, the parameter of lever arm must be increased to achieve the expected torque. As the magnitude of force acting on the crank shaft 12 is determined by the user, the sport and body-building apparatus manufacturer can only consider the wheel diameter of the damper gear 10 and the driving lever arm to determine the final magnitude of revolving inertia of the damper gear 10. However, it is known from the damper gear structure disclosed in FIG. 1, the connection point of the damper gear 10 being driven is on the fitting and contacting point between the crank shaft 12 and the axle hole 11 (as indicated by Arrow L1), and this position is very close to the axle center 13 of the crank shaft 12 (only about 0.5 to 1.5 cm), therefore the magnitude of the lever arm is low. Thus, to achieve the damper gear 10 revolving inertia scale prescribed by related regulations (e.g., 65 kg), by present the only method is to increase the outer diameter of the damper gear 10. However, if the damper gear 10 structure shown in FIG. 1 is used to achieve the regulated revolving inertia scale, practical industrial tests have found that the damper gear 10 outer diameter must be over 50 cm. If such a big damper gear 10 is fitted between the crank shafts 12 stepped by the user, the excessive size will obviously affect the proper configuration of the overall sport and body-building apparatus, and go against the trend of light and handy design. The considerably increased material cost of the damper gear 10 causing bad cost-effectiveness is another problem. Moreover, the oversized damper gear 10 will also pose a concern for operational safety of the user.

Some manufacturers did not consider the influence of the damper gear 10 outer diameter upon the effectiveness of the sport and body-building apparatus, and reduced the outer diameter of the damper gear 10 in the design. However, it is found that such a practice dramatically reduces the effectiveness of the sport and body-building apparatus, and the user can easily feel it. At present, related government authorities of many countries in the world are gradually classifying the effectiveness grades (Class A, B, C, etc.) for such sport and body-building apparatus fitted a damper gear 10, and such classification will directly affect the grade, value and price of such products, which cannot be overlooked by the manufacturers.

Thus, to overcome the aforementioned problems of the prior art, it would be an advancement if the art to provide an improved structure that can significantly improve the efficacy.

Therefore, the inventor has provided the present invention of practicability after deliberate design and evaluation based on years of experience in the production, development and design of related products.

### BRIEF SUMMARY OF THE INVENTION

The “damper gear structure of body-building apparatus” disclosed by the present invention features a unique innovative structure with the central through-hole and driving shaft lever not contacting each other and forming a ring-shaped interval, and an additional configuration of a connecting and positioning member to combine the driving shaft lever with the damper gear main body. Based on such an innovative structure, comparing to prior art, the present invention can deviate the driving and connecting part beyond the outer diameter of the driving shaft lever to increase the lever arm when the driving shaft lever drives the damper gear main body, and achieve the same revolving inertia with relatively reduced outer diameter of the damper gear main body. In this way, the operational effectiveness and production cost effectiveness are both improved. Moreover, due to the reduced outer diameter of the damper gear main body, the peripheral components can be closer or smaller, and consequently the body-building apparatus can have a light and handy design. On the other hand, with the reduced outer diameter of the damper gear main body, it will have less threat and danger to the body and limbs of the user and therefore its operational safety is enhanced.

Another objective of the present invention is that based on the technical characteristics of the configuration of a ring-shaped wall thickness reducing area between the damper gear main body central area and peripheral side part, the center of mass can be moved to the peripheral side part of the damper gear main body, so as to increase the revolving inertia of the damper gear main body. Meanwhile, the material cost is further reduced while maintaining the operational effectiveness.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 is a sectional view of prior art.

FIG. 2 is a plane side view of the present invention fixed on a body-building apparatus.

FIG. 3 is a sectional view of the present invention of a damper gear structure of body-building apparatus.

FIG. 4 is a partially enlarged sectional view of the present invention of a damper gear structure of body-building apparatus.

FIG. 5 is an embodiment of the present invention with the connecting and positioning member made up of a cylinder and end plate.

FIG. 6 is an embodiment of the present invention with the connecting and positioning member made up of a ring frame, a cylinder piece and a one-way bearing.

### DETAILED DESCRIPTION OF THE INVENTION

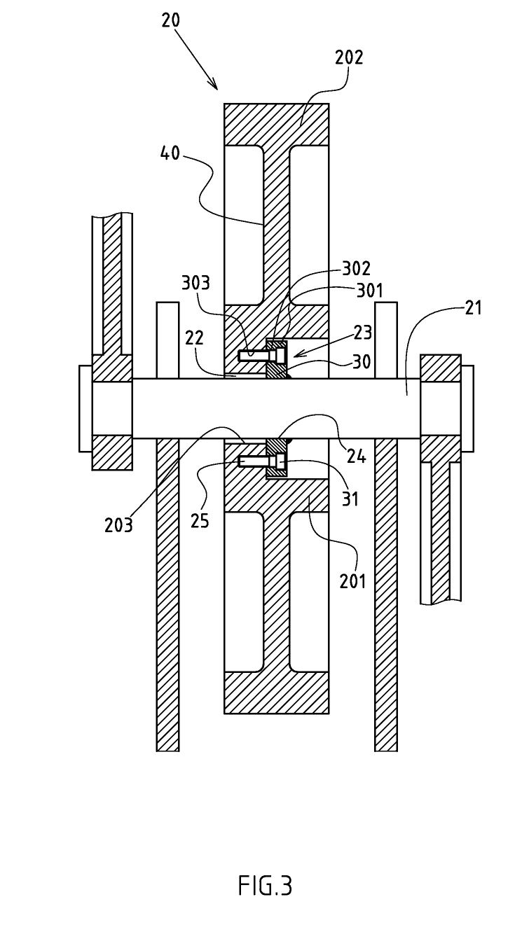

FIGS. 3 to 6 depict a preferred embodiment of the present invention of a damper gear structure of body-building apparatus. However, such an embodiment is illustrative only and is not intending to limit the patent application scope.

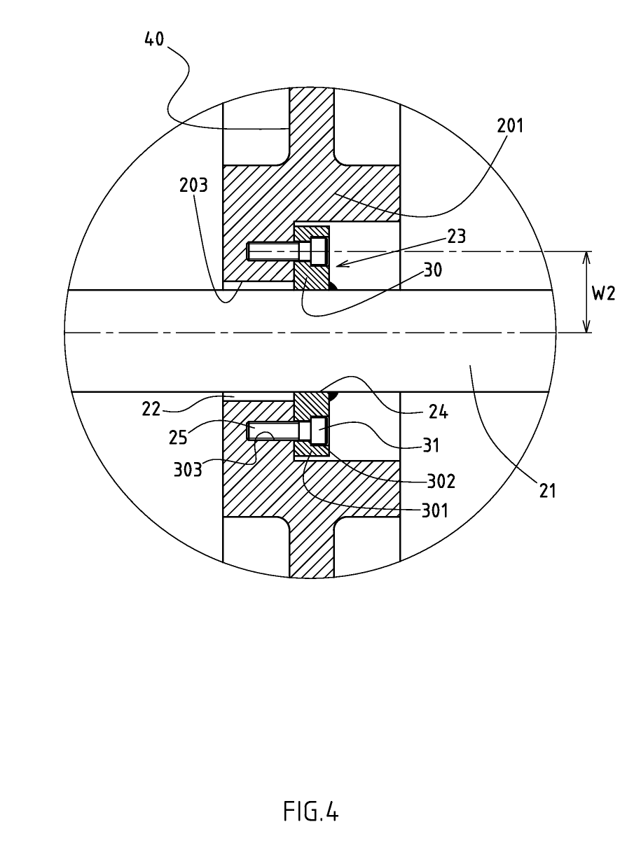

Referring to FIGS. 3 and 4, said damper gear structure of the body-building apparatus 50 comprises a damper gear main body 20, shaped like a round disc and defining a central area 201 and a peripheral side part 202, with the central area 201 configured with a central through-hole 203 to fit the driving shaft lever 21 of the existing body-building apparatus 50.

A ring-shaped interval 22 is formed between the central through-hole 203 and the driving shaft lever 21, so that the central through-hole 203 and the driving shaft lever 21 are coaxial but do not contact each other.

A connecting and positioning member 23 is provided to connect the driving shaft lever 21 and damper gear main body 20, including an axial hole 24 and a connecting and positioning part 25 configured on interval part of the periphery of the axial hole 24, wherein the axial hole 24 is configured to fit the driving shaft lever 21 in a fixed state so they can move together, while the connecting and positioning part 25 is to be fixed on the central area 201 of the damper gear main body 20.

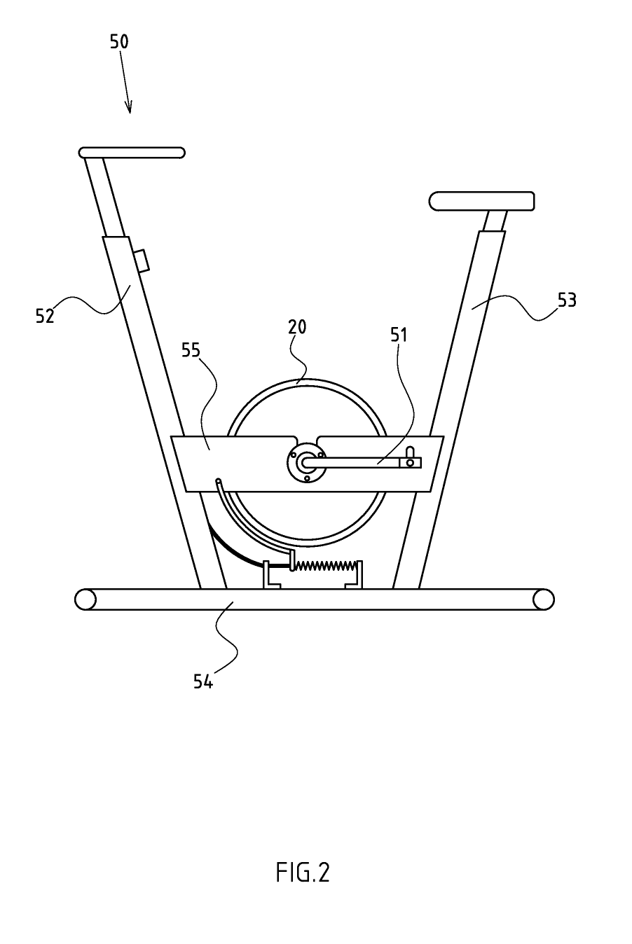

Referring to FIG. 2, the body-building apparatus 50 can comprise a damper gear main body 20, a crank set 51, an arm rest 52, a seat 53, a base 54, and a junction plate 55. The arm rest 52 and seat 53 combines respectively with the base 54, and the junction plate 54 is to combine the arm rest 52 with the seat 53. The damper gear main body 20 is configured with a central through-hole 203 (marked in FIG. 3) to fit the driving shaft lever 21 (marked in FIG. 3). In this way, when the crank set 51 receives a force (for example, foot step) and revolves, it will directly drive the damper gear main body 20 to revolve through the driving shaft lever 21.

Thus, the connecting and positioning part 25 of the connecting and positioning member 23 can be the driving and connecting part (i.e., connecting and positioning part 25) for the driving shaft lever 21 to drive the damper gear main body 20, so that the driving and connecting part can be deviated beyond the outer diameter 21 of the driving shaft lever 21, so as to increase the lever arm W2 (marked in FIG. 4) when the driving shaft lever 21 drives the damper gear main body 20.

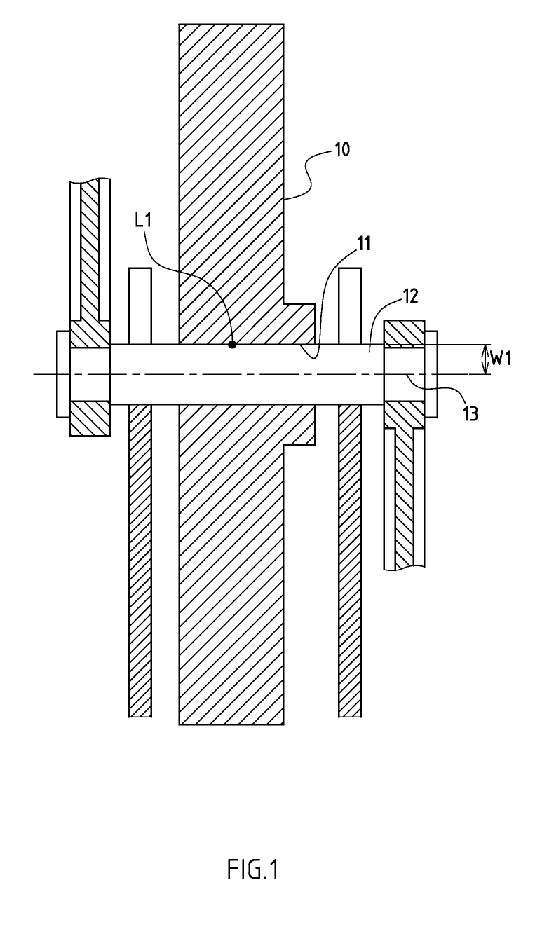

As disclosed in FIG. 4, the lever arm W2 is considerably increased comparing to the lever arm W1 (marked in FIG. 1) in the prior-art structure. Through a comparison between the prior-art structure and the present invention based on the known torque equation (i.e., torque=lever arm×force), it is obvious that the torque achieved by the present invention will be larger than the prior art because the factor of force (i.e., force received by the shaft lever 21) is same, while the parameter of lever arm of the present invention is increased comparing to the prior art. Based on the comparison, if the prior art can achieve a 65 kg revolving inertia by using a 50 cm damper gear, the present invention can achieve a 65 kg revolving inertia while reducing the diameter of the damper gear main body 20 to 40 cm. That is to say, through the unique technical characteristics of a ring-shaped interval 22 formed between the central through-hole 203 and the driving shaft lever 21 on the damper gear main body 20, the present invention can reduce the diameter of the damper gear main body 20 to achieve the same revolving inertia.

Further referring to FIGS. 3 and 4, the connecting and positioning member 23 comprises at least one disc body 30. The disc body 30 contacts against at least one side of the central area 201 of the damper gear main body 20 in a concentric configuration. The axial hole 24 is configured in the center of the disc body 30, and the peripheral side area 301 of the disc body 30 and the central area 201 of the damper gear main body 20 are respectively configured with a plurality of aligned punch holes 302 and screw holes 303 for fixing with bolts 31 to fulfill a fixed state with the disc body 30 tightly contacting against the damper gear main body 20.

Further referring to FIG. 3, between the central area 201 of the damper gear main body 20 and the peripheral side part 202, a ring-shaped wall thickness reducing area 40 is configured to move the center of mass to the peripheral side part 202 of the damper gear main body 20, so as to increase the revolving inertia of the damper gear main body 20.

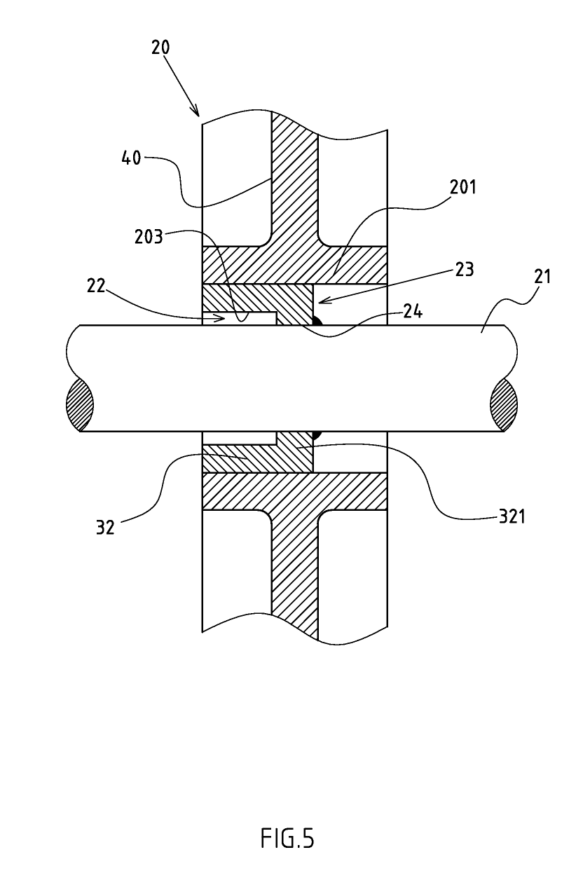

Referring to FIG. 5, the connecting and positioning member 23 can also comprise a cylinder body 32 and an end plate 321, wherein the inner diameter of the hollow cylinder 32 must be larger than the driving shaft lever 21, and the outer diameter of the cylinder 32 is fixed on the central through-hole 203 of the central area 201 of the damper gear main body 20 in a tight and fixed state, the end plate 321 is fixed on one end of the cylinder 32, and the axial hole 24 is configured in the center of the end plate 321. The end plate 321 is fixed with the drive bolt 21 through the axial hole 24, so that when the driving shaft lever 21 is driven, the connecting and positioning member 23 and the damper gear main body 20 can be driven simultaneously.

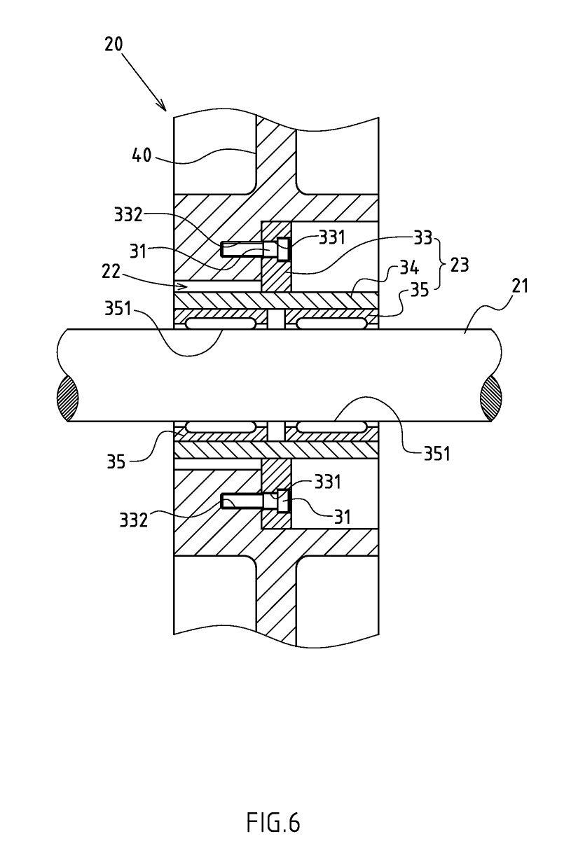

Referring to FIG. 6, the connecting and positioning member 23 can also comprise a ring frame 33, a cylinder piece 34 connecting the center of the ring frame 33, and a one-way bearing 35 configured in the cylinder piece 34, wherein the ring frame 33 contacts against at least one side of the central area 201 of the damper gear main body 20 in a concentric state, and correspondingly, the ring frame 33 and damper gear main body 20 central area 201 are respectively configured with a plurality of aligned punch holes 331 and screw holes 332, for fixing through bolts 31 and achieve a fixed state with the ring frame 33 contacting tightly against the damper gear main body 20. The cylinder piece 34 goes through the central through-hole 203 configured on the damper gear main body 20 without contact. Moreover, the bearing hole 351 of the one-way bearing 35 forms the axial hole 24 for fitting the driving shaft lever 21. In this way, the damper gear main body 20 and the driving shaft lever 21 are coaxial but will not move together.

As a complement, referring to FIGS. 3, 4, and 5, there are various ways (e.g., welding, tight fixing, etc.) to combine the connecting and positioning member 23 with the driving shaft lever 21 through the axial hole 24, so that when the driving shaft lever 21 is driven, the connecting and positioning member 23 and the damper gear main body 20 can be driven together.

1. A damper gear structure of body-building apparatus, comprising:
a damper gear main body, shaped like a round disc and defining a central area and a peripheral side part, with the central area configured with a central through-hole to fit the driving shaft lever of the existing body-building apparatus;
a ring-shaped interval, formed between the central through-hole and the driving shaft lever, so that the central through-hole and the driving shaft lever are coaxial but do not contact each other;
a connecting and positioning member, to connect driving shaft lever and damper gear main body, including an axial hole and a connecting and positioning part configured on interval part of the periphery of the axial hole, wherein the axial hole is configured to fit the driving shaft lever in a fixed state so they can move together, while the connecting and positioning part is to be fixed on the central area of the damper gear main body; thus, the connecting and positioning part of the connecting and positioning member can be the driving and connecting part for the driving shaft lever to drive the damper gear main body, so that the driving and connecting part can be deviated beyond the outer diameter of the driving shaft lever, so as to increase the lever arm when the driving shaft lever drives the damper gear main body; as a result, the outer diameter of the damper gear main body can be relatively reduced to achieve the same revolving inertia.

2. The structure defined in claim 1, wherein the connecting and positioning member comprises at least one disc body; the disc body contacts against at least one side of the central area of the damper gear main body in a concentric configuration; the axial hole is configured in the center of the disc body, and the peripheral side area of the disc body and the central area of the damper gear main body are respectively configured with a plurality of aligned punch holes and screw holes for fixing with bolts to fulfill a fixed state with the disc body tightly contacting against the damper gear main body.

3. The structure defined in claim 1, wherein the connecting and positioning member comprises a cylinder body and an end plate, wherein the inner diameter of the hollow cylinder must be larger than the driving shaft lever, and the outer diameter of the cylinder is fixed on the central through-hole of the central area of the damper gear main body in a tight and fixed state, the end plate is fixed on one end of the cylinder, and the axial hole is configured in the center of the end plate.

4. The structure defined in claim 1, wherein the connecting and positioning member comprises a ring frame, a cylinder piece connecting the center of the ring frame, and a one-way bearing configured in the cylinder piece, wherein the ring frame contacts against at least one side of the central area of the damper gear main body in a concentric state, and correspondingly, the ring frame and damper gear main body central area are respectively configured with a plurality of aligned punch holes and screw holes, for fixing through bolts and achieve a fixed state with the ring frame contacting tightly against the damper gear main body; the cylinder piece goes through the central through-hole configured on the damper gear main body without contact; the bearing hole of the one-way bearing forms the axial hole for fitting the driving shaft lever.

5. The structure defined in claim 1, wherein a ring-shaped wall thickness reducing area configured between the central area of the damper gear main body and the peripheral side part, to move the center of mass to the peripheral side part of the damper gear main body, so as to increase the revolving inertia of the damper gear main body.
